(19) United States
(12) Patent Application Publication
(10) Pub. No.: US 2018/0160671 A1
(43) Pub. Date: Jun. 14, 2018

(54) BOS Stop Drift Spray Wand

(71) Applicant: Victor M Hogue, Addison, TX (US)

(72) Inventor: Victor M Hogue, Addison, TX (US)

(21) Appl. No.: 15/375,101

(22) Filed: Dec. 11, 2016

(51) Int. Cl. A01M 7/00; A01M 21/04

(52) U.S. Cl. CPC A01M 7/0064; A01M 7/0046; A01M 21/043

(57) ABSTRACT

A spray device for spraying a fluid may include a reservoir to hold the fluid; a hose connected to the reservoir to convey the fluid; a handle to connect to the hose; a telescoping dispensing shaft connected to the handle to convey the fluid; and a dome connected to the telescoping dispensing shaft to encapsulate the excess drift.

The dome may be formed from one of translucent or clear material.

### FIELD OF THE INVENTION

The present invention relates generally to spray guards for fluid dispensers and more particularly to a method and device for spraying chemicals from a spray wand that provides “pin-point” accuracy and eliminates the chemical spray from drifting to unwarranted targets.

### BACKGROUND

Weed control is a necessary part of everyday life. Weeds choke off the sunlight and nutrients from plants which are desirable. Pulling weeds from the ground is generally unsatisfactory because of the un-ability to completely remove all the roots of the weeds. Chemical spraying is desirable because once weeds have been sprayed with a sufficient quantity of chemicals the entire weed including the roots die off.

It would be desirable to treat weeds when there is absolutely no wind. However, this atmospheric condition is difficult to achieve and realistically, weeds spraying is done when there is little or moderate airflow. Even a small amount of airflow can interact with the chemical spraying by lifting the chemical spray from the end of the spray device and depositing the chemical spray on wanted plants. This misplaced chemical spray may be sufficient to kill the wanted plants. This of course defeats the purpose of spraying.

What is needed is a way to avoid the application of the misplaced chemical spray.

### SUMMARY

A spray device for spraying a fluid may include a reservoir to hold the fluid; a hose connected to the reservoir to convey the fluid; a handle to connect to the hose; a telescoping dispensing shaft connected to the handle allowing a more comfortable adjustment to the user, to convey the fluid; and a dome connected to the telescoping dispensing shaft to encapsulate the excess drift. The dome may be formed from one of translucent or clear material.

A spray device for spraying a fluid may include a trigger to control the flow of the fluid;

A spray device for spraying a fluid may include a fluid to control weeds.

A spray device for spraying a fluid may include a flexible hose.

A spray device for spraying a fluid may include the reservoir that may be adapted to hold pressurized fluid.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the spray device of the present invention;

FIG. 2 illustrates a perspective view of another embodiment of the spray device of the present invention;

FIG. 3 illustrates a bottom view of the dome of the present invention;

FIG. 4 illustrates a cross-sectional view of the telescoping dispensing shaft of the present invention.

### DETAILED DESCRIPTION

The BOS “Stop Drift” Spray Wand allows the user to kill weeds in Planter Beds, Driveway cracks, Side Walk cracks, Curb cracks all the while preventing the excess liquid sprayed that usually turns into Vapor/Drift from reaching any unwarranted targets, such as Plants, Shrubs, Flowers, Grass, Children, Playground Toys, Dog Food Bowel and Water Containers. In the Landscape Industry, it is common knowledge that spraying weeds is part of the general contract for residential and commercial properties. The BOS “Stop Drift” Spray Wand may help reduce the insurance liabilities commonly caused by spraying chemicals of any kind around the public. However, part of the service contract for Landscape Crews Nationwide, when servicing commercial or residential properties is to maintain weeds in planter beds, concrete crack weeds on sidewalks, curbs, and around building, near the front door entry to buildings and in the foundation next to building, always subjecting the public to chemical drift. The BOS “Stop Drift” Spray Wand was designed to comfortably target the weed by placing the capsule/dome over the weed, encapsulating the entire weed target and pulling the trigger, releasing the liquid chemical on to the target. It has extendable a wand so that the length will adjust to the user's height, so to provide additional comfort in using the product. User will be able to target weeds thru the water clear capsule without bending over. The capsule is designed so that the user can easily see the weed target through the water clear plastic so that he knows when to spray over the weed making a direct contact.

The BOS “Stop Drift” Wand sprays herbicide (weed killer) onto specifically targeted weeds, while it will encapsulate or trap any chance of vapor/drift inside the capsule while the weed killer is dispersed on the target weed, while purposely preventing any chance of drift from reaching unwarranted objects outside the capsule.

The capsule has a dispensary type nozzle attached on the underneath side, and the wand, when attached to one capsule becomes the clear capsule, extendable wand, and nozzle assembly, designed to perform as described above.

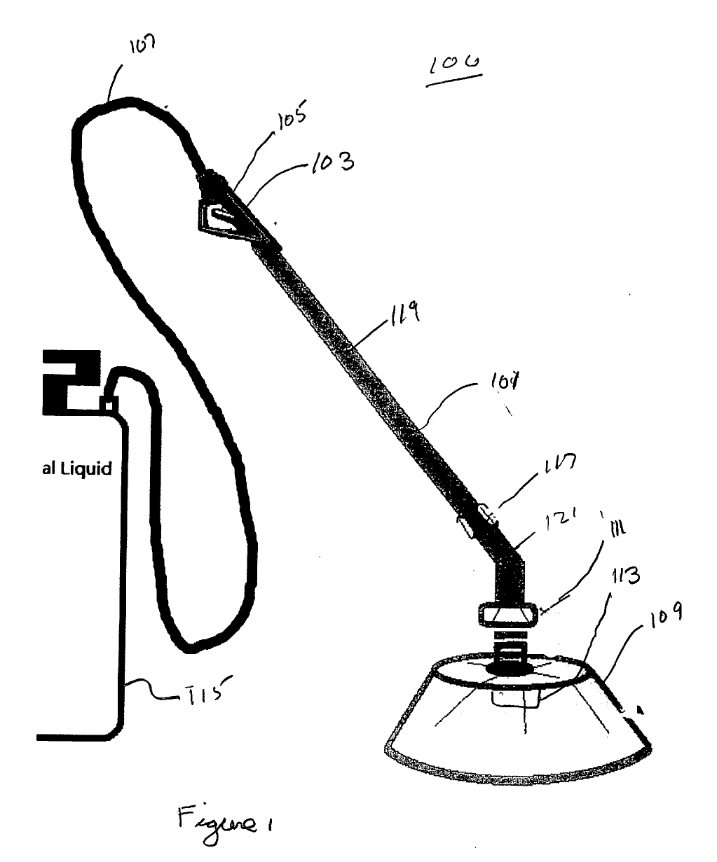

FIG. 1 illustrates a spraying device 100 of the present invention which may include a reservoir 115 of fluid which may be a liquid suitable to kill weeds. The reservoir 115 may include a pressure device (not shown) to pressurize the fluid, and the reservoir 115 may be connected to a flexible hose 107 to supply the fluid to the spray device 100. The flexible hose 107 may be connected to a handle device 103 to allow the user to direct the pressurized fluid to the target weed (not shown), and the handle device 103 may include a trigger 105 to allow the control of the pressurized fluid by allowing the pressurized fluid to flow or not flow into the telescoping dispensing shaft 101 which may be connected to the handle device 103. The telescoping dispensing shaft 101 may be lengthened or shortened to allow the user to determine the most convenient length by adjusting the telescoping control 117; by rotating the telescoping control 117 the upper portion 119 may lengthen or retract with respect to the lower portion 121. The telescoping dispensing shaft 101 may have a central aperture 123 which may extend longitudinally along the shaft 101. The telescoping dispensing shaft 101 may be connected to a truncated dome 125 which may be clear or translucent to allow the user to view the object (not shown) being covered by the truncated dome 125 by a connector 111 which may include male and female threads to detachably connect the truncated dome 125 to the telescoping dispenser shaft 101. The connector 111 may be connected to a spray element 113 to dispense the pressurized fluid within the cavity defined by the truncated dome 125, and the central aperture 123 is in communication with the spray element 113.

The fluid is pressurized within the reservoir 115 and flows within the flexible hose 107, and the flow of the pressurized fluid is controlled by the trigger 105 of the handle device 103. The pressurized fluid flows through the central aperture 123 of the telescopic dispensing shaft 101, and flows into the cavity of the dome 109. The spray element 113 dispense is the fluid within the cavity of the dome 109.

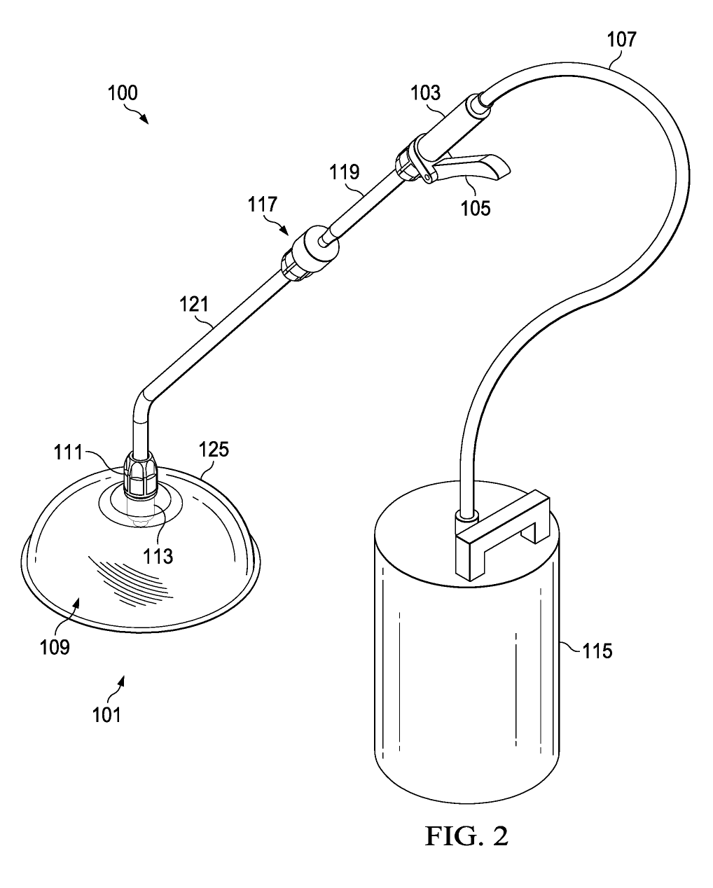

FIG. 2 illustrates another embodiment of the spraying device 100 and illustrates the telegraphing dispensing shaft 101, the connector 111 and an un-truncated dome 130.

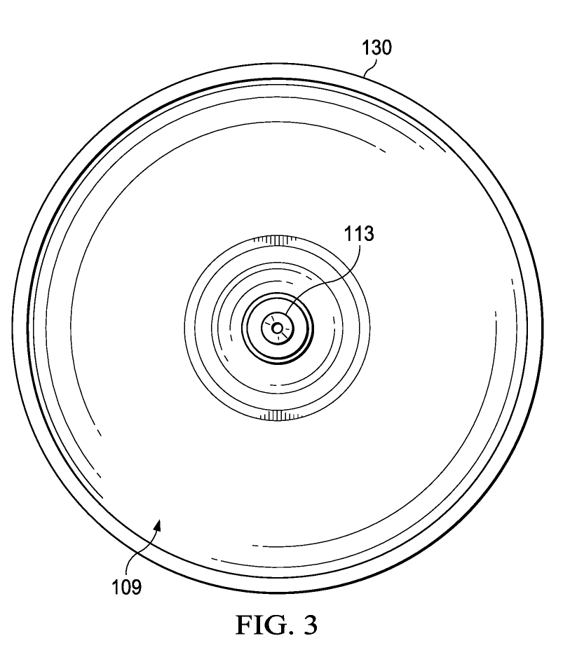

FIG. 3 illustrates a bottom view of the dome 130 and the spray element 113 of the present invention;

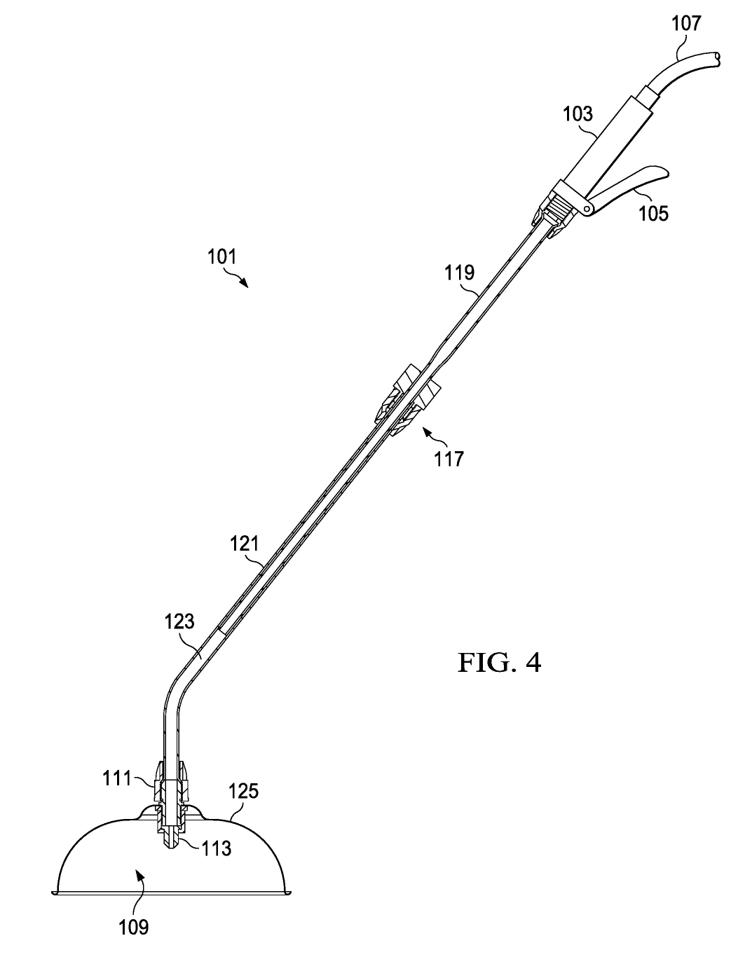

FIG. 4 illustrates a cross-sectional view of the telescoping dispensing shaft 101 and of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A spray device for spraying a fluid, comprising:
a reservoir to hold the fluid;
a hose connected to the reservoir to convey the fluid;
a handle connected to the hose;
a telescoping dispensing shaft adjustable to a user, connected to the handle to convey the fluid; and
a capsule, the telescoping dispensing shaft having a first state connected to the capsule and a second state detached from the capsule, the capsule comprising:
a dome that encapsulates excess fluid composed of vapor droplets; and
a spray element attached to the dome on an underside of the dome,
wherein the dome is formed from one of translucent or clear material.

2. A spray device for spraying a fluid as in claim 1, wherein the handle includes a trigger to control the flow of the fluid through the telescoping dispensing shaft.

3. A spray device for spraying a fluid as in claim 1, wherein the fluid is a fluid to control weeds.

4. A spray device for spraying a fluid as in claim 1, wherein the hose is a flexible hose.

5. A spray device for spraying a fluid as in claim 1, wherein the reservoir is adapted to hold pressurized fluid.

6. A spray device for spraying a fluid as in claim 1, wherein the spray element is a dispensary type nozzle.

7. A spray device for spraying a fluid as in claim 1, further comprising a connector that detachably connects the telescoping dispensing shaft to the capsule to provide the first state connected to the capsule.

8. A spray device for spraying a fluid as in claim 7, wherein the connector includes one of male and female threads.

9. A spray device for spraying a fluid as in claim 1, wherein the telescoping dispensing shaft has a central aperture.

10. A spray device for spraying a fluid as in claim 9, wherein the central aperture of the telescoping dispensing shaft is in communication with the spray element when the telescoping dispensing shaft is in its first state connected to the capsule.

11. A spray device for spraying a fluid as in claim 1, wherein the spray element dispenses fluid within a cavity of the dome.

12. A spray device for spraying a fluid, comprising:
a reservoir to hold the fluid;
a hose connected to the reservoir to convey the fluid;
a handle connected to the hose;
a telescoping dispensing shaft adjustable to a user, connected to the handle to convey the fluid;
a dome that encapsulates excess fluid composed of vapor droplets, the dome being formed from one of translucent or clear material; and
a spray element attached to the dome on an underside of the dome, and
wherein the telescoping dispensing shaft is detachable from the dome while the spray element is attached to the dome.

13. A spray device for spraying a fluid as in claim 12, wherein the handle includes a trigger to control flow of the fluid through the telescoping dispensing shaft.

14. A spray device for spraying a fluid as in claim 12, wherein the fluid is a fluid to control weeds.

15. A spray device for spraying a fluid as in claim 12, wherein the spray element is a dispensary type nozzle.

16. A spray device for spraying a fluid as in claim 12, further comprising a connector that detachably connects the telescoping dispensing shaft to the dome.

17. A spray device for spraying a fluid as in claim 16, wherein the connector includes one of male and female threads.

18. A spray device for spraying a fluid as in claim 12, wherein the telescoping dispensing shaft has a central aperture.

19. A spray device for spraying a fluid as in claim 18, wherein the central aperture of the telescoping dispensing shaft is in communication with the spray element when the telescoping dispensing shaft is connected to the capsule.

20. A spray device for spraying a fluid as in claim 12, wherein the spray element dispenses fluid within a cavity of the dome.
